(19) United States
(12) Patent Application Publication
(10) Pub. No.: US 2015/0042623 A1
(43) Pub. Date: Feb. 12, 2015

(54) INFORMATION PROCESSING APPARATUS AND COMPUTER PROGRAM

(71) Applicant: TOSHIBA TEC KABUSHIKI KAISHA, Tokyo (JP)

(72) Inventor: Hiroyuki Kato, Mishima-shi (JP)

(21) Appl. No.: 14/444,282

(22) Filed: Jul. 28, 2014

(30) Foreign Application Priority Data
Aug. 8, 2013 (JP) 2013-164779

(51) Int. Cl. G06F 3/041

(52) U.S. Cl. CPC G06F 3/0418; G06F 3/0412; G06F 2203/04104
USPC 345/178

(57) ABSTRACT

According to one embodiment, an information processing apparatus includes a display unit of a panel type, a touch panel type input unit stacked and arranged on the display unit and configured to receive an operation input of a user through touch detection, and a control unit. If the input unit repeatedly receives the same user operation a plurality of times, the control unit executes a command conforming to first operation associated with the user operation.

### CROSS-REFERENCE TO RELATED APPLICATION

This application is based upon and claims the benefit of priority from Japanese Patent Application No. 2013-164779, filed Aug. 8, 2013, the entire contents of which are incorporated herein by reference.

### FIELD

Embodiments described herein relate generally to a technique to receive operation on a touch panel and execute a command corresponding to the operation.

### BACKGROUND

There is a computer in which a multi-touch panel for detecting a plurality of touches is adopted as an input device. Besides, there is a tabletop computer in which this touch panel is further enlarged and is adopted as a table top. The tabletop computer allows a large number of people to simultaneously perform operation and hold a meeting and a presentation.

The user brings a fingertip or a pen tip into contact with an image area displayed on the touch panel and moves the finger tip or the pen tip. Commands such as movement, enlargement, and reduction of the image are executed.

In some case, operation on the touch panel by the user (hereinafter referred to as gesture) is misrecognized. Even if the user executes the operation many times, a desired command is not executed.

Embodiments described herein have been made to solve the problems described above, and an object thereof is to provide a technique for suppressing misdetection of operation performed by a user and allowing a command desired by the user to be executed.

### DESCRIPTION OF THE DRAWINGS

FIG. 1 is a diagram showing an external appearance of a tabletop information processing apparatus according to an embodiment;

FIG. 2 is a diagram showing a hardware configuration example of the tabletop information processing apparatus;

FIG. 3 is a diagram of the tabletop information processing apparatus viewed from an upper side;

FIGS. 4A to 4C are diagrams showing examples of data tables used in the embodiment;

FIG. 5 is a flowchart for explaining an operation example according to the embodiment; and

FIG. 6 is a diagram showing a configuration example according to the embodiment for causing a server to store various data.

### DETAILED DESCRIPTION

In general, according to one embodiment, an information processing apparatus includes: a display unit of a panel type; a touch panel type input unit stacked and arranged on the display unit and configured to receive an operation input of a user through touch detection; and a control unit. If the input unit repeatedly receives the same user operation a plurality of times, the control unit executes a command conforming to first operation associated with the user operation.

If the same operation pattern (gesture) continues a specified number of times or more, the information processing apparatus according to the embodiment determines that the gesture is misrecognized, corrects gesture recognition content, and executes operation desired by the user.

If a specific gesture is performed, the information processing apparatus according to the embodiment executes a command corresponding to the gesture. The command according to the embodiment is a command for operation with respect to a displayed image and is, for example, movement, enlargement, reduction, deletion, and selection of the displayed image. The information processing apparatus according to the embodiment determines for which displayed image the same gesture is continuously repeated and how many times the same gesture is repeated. If the same gesture is performed a plurality of times within a predetermined time, the information processing apparatus according to the embodiment determines that the gesture is misrecognized.

If the same gesture is continuously repeated for the same displayed image a specified number of times or more, the information processing apparatus according to the embodiment inquires the user about another execution command candidate. In the inquiry, the information processing apparatus indicates a method of using a desired function and a correct method of performing a gesture. The user can select whether the methods are displayed. Display order of execution command candidates is set on the basis of the number of misdetections of gestures and an evaluation point obtained from the user.

If the same gesture is continuously repeated for the same object a specified number of times or more, the information processing apparatus according to the embodiment can also automatically determine another execution command close to an operation intention of the user and automatically execute the command.

In the embodiment, the user evaluates a result determined by the information processing apparatus. The information processing apparatus stores, for each of users, the number of times misrecognition content of a gesture is corrected (the number of misdetections) and uses stored content for the next correction.

The stored correction content can be shared by a plurality of apparatuses.

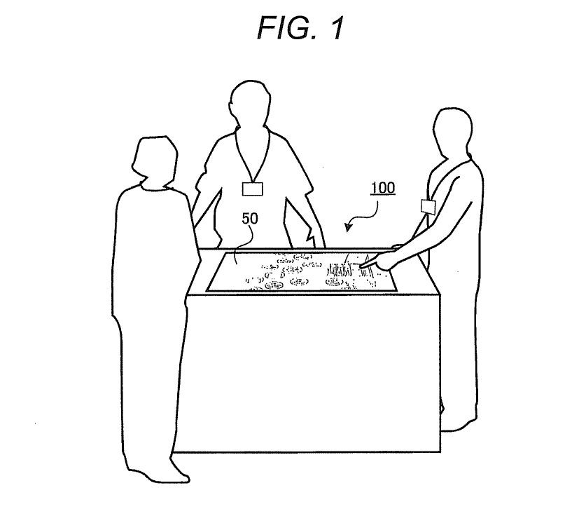

A form according to an embodiment is explained below with reference to the drawings. FIG. 1 is a diagram showing an external appearance of a tabletop information processing apparatus according to the embodiment. A tabletop information processing apparatus 100 is an information processing apparatus of a table type (a tabletop type). A large touch panel display 50 for operation display is arranged on a top plate surface of the tabletop information processing apparatus 100.

In the touch panel display 50, a multi-touch sensor (an input unit) that simultaneously detects a plurality of touch positions is stacked and arranged on a display unit of a panel type. An image on a screen can be controlled by a fingertip or a pen tip. The touch panel display 50 enables various content images to be displayed. The touch panel display 50 also plays a role of a user interface for an operation input.

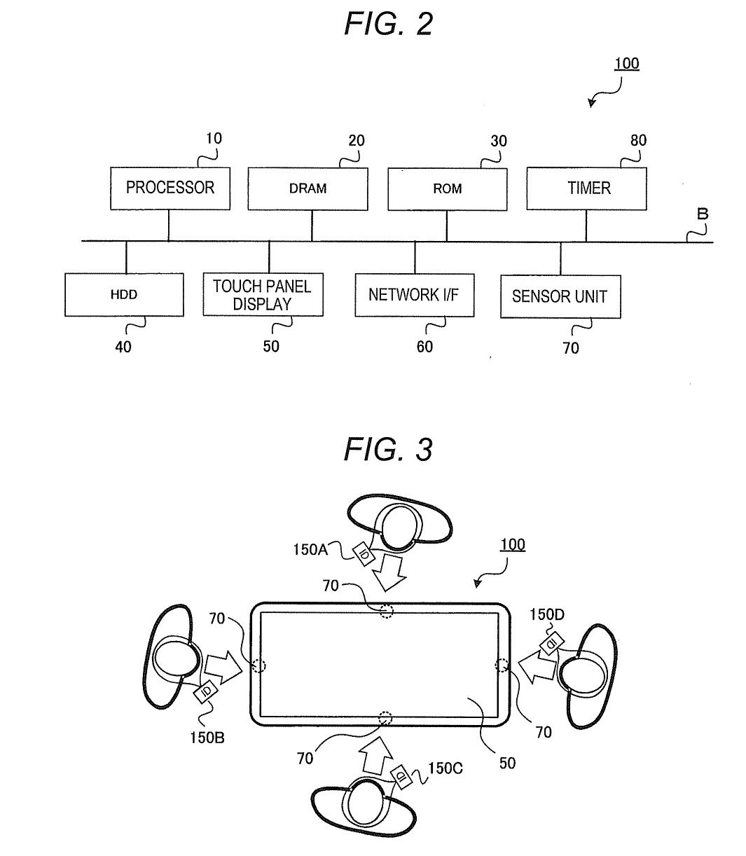

FIG. 2 is a block diagram showing an example of a hardware configuration of the inside of the tabletop information processing apparatus 100. The tabletop information processing apparatus 100 includes a processor 10, a DRAM (Dynamic Random Access Memory) 20, a ROM (Read Only Memory) 30, a HDD (Hard Disk Drive) 40, a touch panel display 50, a network I/F (Interface) 60, a sensor unit 70, and a timer 80. These devices perform transmission and reception of control signals and data each other through a communication bus B.

The processor 10 is an arithmetic processing unit such as a CPU (Central Processing Unit) . The processor 10 loads a computer program stored in the ROM 30, the HDD 40, or the like to the DRAM 20 and executes an operation to perform various kinds of processing according to the computer program. The DRAM 20 is a volatile main storage device. The ROM 30 is a nonvolatile storage device for permanent storage. For example, a BIOS (Basic Input Output System) for system startup is stored in the ROM 30. The HDD 40 is a nonvolatile auxiliary storage device capable of performing permanent storage. The HDD 40 stores data and a computer program to be used by a user.

The touch panel display 50 is configured by a touch panel type input unit of a capacitance type (a touch panel type input unit) and a display unit of a flat panel (a display unit of a panel type). The touch panel is adapted to multi-touch for detecting a plurality of simultaneous touches and can obtain coordinate values (an X value and a Y value) corresponding to a touch position. The flat panel includes light-emitting elements for display over the entire surface of the panel.

The network I/F 60 is a unit that performs communication with an external apparatus and includes a LAN (Local Area Network) board. The network I/F 60 includes a device conforming to a short-distance radio communication standard and a connector conforming to a USB (Universal Serial Bus) standard.

The sensor unit 70 is a unit that detects an ID (Identification) card owned by the user and reads information described in the ID card. The read information is used for, for example, login authentication for the tabletop information processing apparatus 100. The ID card is an IC card of a non-contact type. At least identification information of the user is stored in the ID card. The timer 80 is a unit that clocks the present time.

FIG. 3 is a plan view of the tabletop information processing apparatus 100 viewed from an upper side. The tabletop information processing apparatus 100 enables simultaneous login of a plurality of users. In this embodiment, a plurality of (in this embodiment, four in total) the sensor units 70 are respectively arranged in the centers on four side surfaces near the top plate. When the users carrying ID cards 150A to 150D approach the sensor units 70, the sensor units read information stored in the ID cards and login authentication is performed. If the information stored in the ID cards is registered in the HDD 40 or an external authentication mechanism in advance, authentication is matched.

The tabletop display apparatus 100 displays, to an authenticated user, a desktop screen customized for each of the users. The user performs work such as document editing and browsing of any Web page in the desktop screen. The displayed objects (a displayed image and an aggregate of data tied to the image are hereinafter referred to as objects) can be, for example, moved, enlarged, reduced, rotated, selected, and deleted according to predetermined operation of the user using a publicly-known technique.

For example, it is assumed that there is operation for deleting an object (erasing display from a screen) by bringing the five fingers into contact with the touch panel display 50 and performing a gesture for picking up a displayed object. In some case, even if the user repeatedly performs the operation for “picking up with the five fingers” many times, an object is not deleted and the operation is recognized as another command such as “reduction of an object”. If the same operation is repeatedly performed in this way, the tabletop information processing apparatus 100 performs any one of the following:

displaying a list of other prospective commands and executing a command selected by the user out of the commands; and

automatically executing a command set in advance out of other prospective candidates.

In a page turning gesture, the same operation continues. However, in this embodiment, the tabletop information processing apparatus 100 does not determine that the gesture is misrecognized. The tabletop information processing apparatus 100 recognizes a different page as a different object and determines that the page turning gesture does not correspond to continuous operation for the same object. If the same operation continues within predetermined time from the start of operation, the tabletop information processing apparatus 100 determines that a gesture is misrecognized.

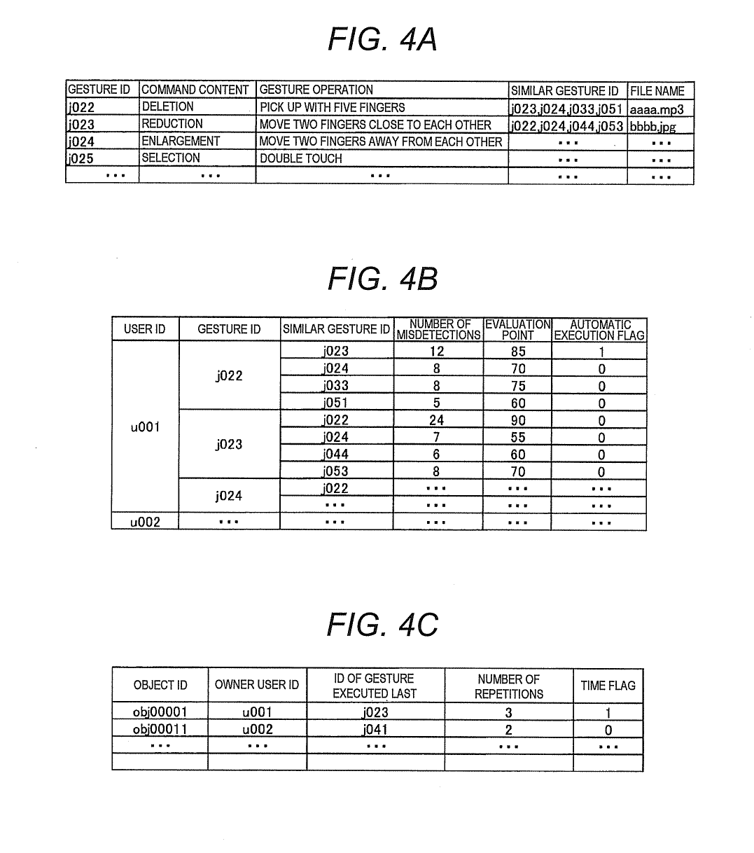

FIGS. 4A to 4C are examples of information stored in the storing unit of the DRAM 20 or the HDD 40. Tables shown in the figures are explained.

FIG. 4A is a table in which information concerning gestures are summarized. The table shown in FIG. 4A is a table in which respective kinds of information concerning identification information (an ID) of a gesture, command content of the gesture, a specific operation procedure of the gesture, an ID of gestures similar to the gesture, and a file name are collected as one record. For example, a gesture with a gesture ID “j022” is associated with a command for deleting an object from display. Gesture operation of the gesture is operation for “picking up with the five fingers”. Data stored in a command content column and a gesture operation column is text data and is data for notifying the user of command content and a method of performing the gesture.

The similar gesture ID is data describing gestures similar to the gesture. For example, gestures similar to the gesture with the gesture ID “j022” are gestures given with IDs “j023”, “j024, “j033”, and “j051”. The file name is a name of an image file or a moving image file for explaining a method of performing the gesture. Data of this video file is displayed on the touch panel display 50 when an operation method is shown to the user. The table shown in FIG. 4A is a table defined beforehand. A maintenance person performs predetermined operation according to necessity to update the table.

FIG. 4B is a table in which a user, the numbers of misdetections that occur when the user performs gestures, evaluation points, and the like are associated. When the processor 10 registers a user anew, the processor 10 registers the user in the table. When the processor 10 cancels (deletes) registration of a user, the processor 10 deletes a user ID corresponding to the user and a record associated with the user ID.

The table shown in FIG. 4B includes user identification information (ID), a gesture ID, and IDs of gestures similar to the gesture ID. As the gesture ID and the similar gesture IDs, data are associated in the same manner as the data shown in FIG. 4A. For example, in FIG. 4A, the gesture IDs similar to the gesture ID “j022” are “j023”, “j024”, “j033”, and “j051”. Association same as this association is formed in the table shown in FIG. 4B.

The number of misdetections is numerical value data obtained by counting the number of times if a performed gesture is determined as a similar gesture (i.e., the number of times the gesture is misdetected). The number of misdetections is a value set by the processor 10 of the tabletop information processing apparatus 100. The evaluation point is a value set by the user. Concerning a similar gesture for which the user determines that misdetection frequently occurs, a high numerical value is set. Concerning a similar gesture for which the user does not determine that the misdetection frequently occurs, a low numerical value is set. The processor 10 obtains the evaluation point via an input screen displayed according to predetermined operation of the user. The number of misdetections and the evaluation point affect the order of command candidates displayed after a gesture is determined as being misdetected.

An automatic execution flag is data set by the user. If the automatic execution flag is 1 (ON), when misdetection occurs, the processor 10 executes a command of the similar gesture ID without displaying command candidates. This flag data can be set to ON for only one similar gesture for one gesture ID. For example, concerning a gesture with the gesture ID “j022” in the gesture ID column, in an example shown in FIG. 4B, a flag is set in a record of a similar gesture ID “j023”. In this case, the automatic execution flag cannot be set for the other similar gesture IDs (j024, j033, and j051). Values of the execution flag is 0 (OFF). A replacement screen for the flag is displayed when the user performs predetermined operation. The processor 10 can obtain a value from the user via this screen.

It is also possible to adopt implementation for automatically executing a similar gesture on the basis of the number of misdetections and the evaluation point, for example, automatically executing a similar gesture having a largest total value of the number of misdetections and the evaluation point. The processor 10 may select, according to any one of the number of misdetections and the evaluation point, a gesture to be automatically executed.

FIG. 4C is a table showing how many times the same gesture is repeated for an object. When an object is displayed, the processor 10 registers one record. When an object is deleted in display, the processor 10 deletes a record corresponding to the object. An object ID is identification information of a displayed object. An owner user ID is a user ID indicating an owner of the object. It is assumed that, in this embodiment, the owner is a user who invokes and displays the object. In this table, an ID of a gesture executed last is stored. A column of the ID of the gesture executed last is updated if the processor 10 recognizes that the present gesture is different from the last gesture.

The number of repetitions in a table shown in FIG. 4C is numerical value data indicating how many times the gesture executed last is continuously executed. The number of repetitions is initialized to be zero if a gesture different from the gesture executed last is executed and if a time flag is OFF. The time flag is data that is set to ON (a value 1) if an object is touched and is set to OFF (a value 0) when a predetermined period elapses counted from the time when the data is set to ON. In this embodiment, the predetermined period is 10 seconds. If the same gesture is repeatedly performed during a period in which the time flag is ON, the processor performs display of command candidates and automatic execution of candidate commands.

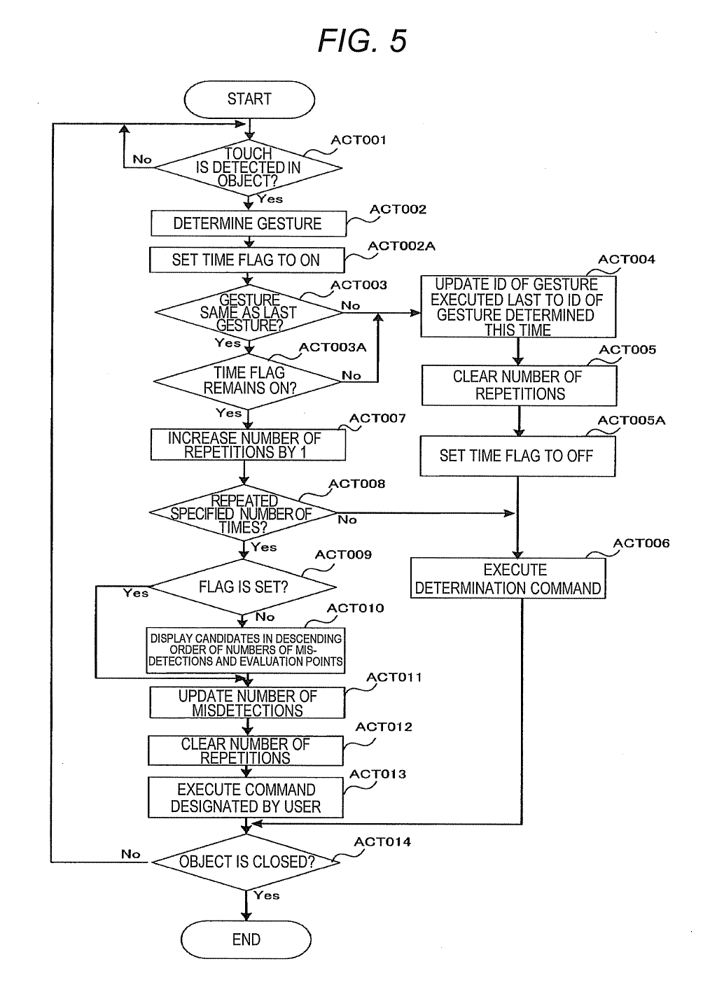

FIG. 5 is a flowchart for explaining an operation example of the tabletop information processing apparatus 100. The operation shown in FIG. 5 is executed when the processor 10 loads a computer program stored in the HDD 40 in advance to the DRAM 20, executes operation according to a program code of the computer program, and cooperates with other hardware.

The processor 10 determines whether a touch of a fingertip or a pen tip occurs in an object displayed on the touch panel display 50 (ACT 001). This determination is based on the related art. The processor 10 stays on standby until a touch is detected (ACT 001, a loop of No). If a touch occurs (ACT 001, Yes), the processor 10 determines, on the basis of information concerning to where a detection position moves thereafter and information concerning, for example, whether the touch is detected a plurality of times in a short time, a gesture performed by the user and determines a command conforming to the gesture (ACT 002).

The processor 10 sets a time flag corresponding to the object, in which the touch is detected, to ON (ACT 002A). Consequently, the time flag shown in FIG. 4C is set to 1. The processor 10 executes, separately from and in parallel to this processing, processing for, if the processor 10 sets the time flag to ON, acquiring the present time from the timer 80 and counting time until 10 seconds elapses from the time when the time flag is set to ON. If 10 seconds elapses, the processor sets the time flag to zero asynchronously with this processing.

The processor 10 determines whether the gesture determined in ACT 002 is a gesture same as the last gesture (ACT 003). This determination is performed by comparing the ID of the gesture executed last shown in FIG. 4C and an ID of the gesture determined this time. If the gesture determined this time is a gesture different from the last gesture (ACT 0003, No), the processor 10 treats the gesture determined this time as a new gesture and initializes the various data shown in FIG. 4C. That is, the processor 10 updates the ID of the gesture executed last shown in FIG. 4C to the ID of the gesture determined this time (ACT 004) and clears the number of repetitions to zero (ACT 005). If the time flag is ON, the processor 10 sets the time flag to OFF (ACT 005A).

The processor 10 executes the command determined in ACT 002 (ACT 006). Thereafter, the processor 10 performs determination processing in ACT 014.

Returning the explanation to ACT 003, if the gesture determined this time is a gesture same as the last gesture (ACT 003, Yes), the processor 10 refers to the time flag shown in FIG. 4C and determines whether the time flag remains ON (ACT 003A). If the time flag is OFF (ACT 003A, No), since time equal to or longer than the specified time of 10 seconds elapses, the processor 10 treats the gesture determined this time as a new gesture and initializes the various data shown in FIG. 4C. Therefore, in this embodiment, if the time flag is OFF, the processor 10 proceeds to ACT 004 or ACT 005.

If the time flag is ON (ACT 003A, Yes), the processor 10 increases the number of repetitions of the table shown in FIG. 4C by one (ACT 007). The processor 10 compares the number of repetitions and a specified number (e.g., 5) and determines whether the same gesture is repeatedly performed by the specified number (ACT 008). If the number of repetitions is smaller than the specified number (ACT 008, No), the processor 10 executes the command determined in ACT 002 (ACT 006). Thereafter, the processor 10 performs the determination processing in ACT 014.

If the gesture is repeatedly executed by the specified number (ACT 008, Yes), the processor 10 refers to the table shown in FIG. 4B and determines whether a similar gesture, the automatic execution flag of which is ON, is present (ACT 009).

A search method until acquisition of a similar gesture, the automatic execution flag of which is ON, is explained. The processor 10 refers to the table shown in FIG. 4C using an ID of an operation target object and acquires an owner user ID of a relevant record. The processor 10 refers to the table shown in FIG. 4B and acquires one or a plurality of records in which owner user IDs are present in the user ID column and the ID of the gesture determined in ACT 002 is present in the gesture ID column. The processor 10 searches for a record in which the automatic execution flag is ON among the records. If there is a relevant record, the processor 10 acquires the similar gesture ID of the record.

Returning to the explanation of the flowchart, if a similar gesture, the automatic execution flag of which is ON, is present (ACT 009, Yes), the processor 10 proceeds to ACT 011. It is also possible to adopt implementation for advancing the processor 10 to ACT 012 rather than ACT 011.

On the other hand, if a similar gesture, the automatic execution flag of which is ON, is absent (ACT 009, No), the processor 10 displays candidates of gestures and command contents as a list in descending order of the numbers of misdetections and evaluation points (ACT 010).

An operation in ACT 010 is explained. The processor 10 acquires, from the table shown in FIG. 4B, records in which the owner user IDs and the ID of the gesture determined in ACT 002 coincide with each other and creates a list of the similar gesture IDs, the numbers of misdetections, and the evaluation points. Subsequently, the processor 10 acquires a record in which the acquired similar gesture ID and the gesture ID column of the table shown in FIG. 4A coincide with each other, acquires data of command content and gesture operation of a relevant record, and associates the data with the list of the numbers of misdetections and the evaluation points. The processor 10 sorts the list and displays the numbers of misdetections and the evaluation points in descending order. Concerning the ordering of the candidates, there are various kinds of implementation for, for example, adding up the numbers of misdetections and the evaluation points and displaying added-up values of the numbers of misdetections and the evaluation points in descending order. The ordering may be performed for only any one of the numbers of misdetections and the evaluation points, for example, in descending order of only the numbers of misdetections or descending order of only the evaluation points.

Other than displaying the operation method as a text, the processor 10 may adopt implementation for acquiring a file name referring to the table shown in FIG. 4A and displaying a relevant image or reproducing a moving image. The processor 10 may adopt implementation for not displaying the gesture method on the basis of user designation.

Returning to the explanation of the flowchart, the touch panel display 50 detects which gesture among the gesture candidates is selected. The processor 10 refers to the table shown in FIG. 4B, adds 1 to the number of misdetections corresponding to a gesture candidate (a similar gesture ID) selected by the user, and updates the number of misdetections (ACT 011). Thereafter, the processor 10 initializes the data shown in FIG. 4C. That is, the processor 10 clears the number of repetitions shown in FIG. 4C (ACT 012). If the time flag remains ON at this point, the processor 10 sets the time flag to OFF.

The processor 10 executes a command conforming to the gesture designated by the user (ACT 013). If the determination in ACT 009 is affirmative, that is, if a similar gesture, the automatic execution flag is ON, is present, the processor 10 executes a command conforming to the similar gesture set to ON (ACT 013).

The operation of ACT 001 to ACT 013 is repeatedly executed until the object is deleted in display (Act 014, a loop of No).

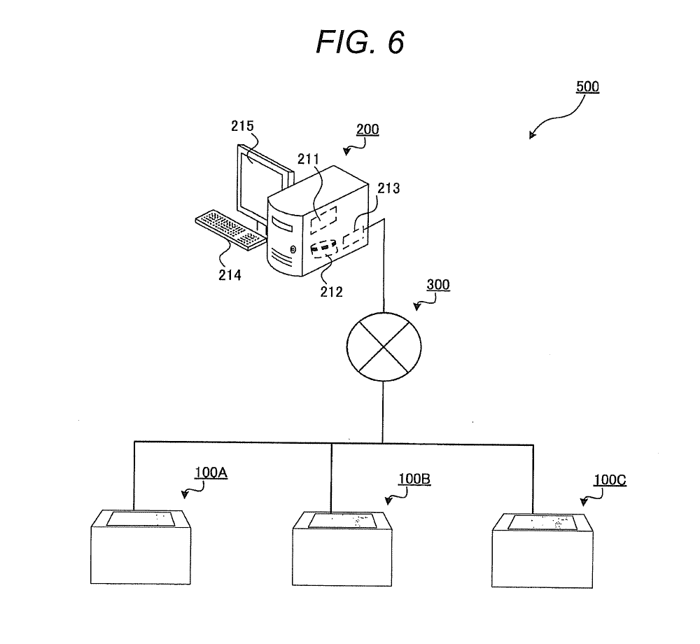

It is also possible to adopt implementation for storing the tables shown in FIGS. 4A to 4C in an external server and causing a plurality of the tabletop information processing apparatuses 100 to share data. A configuration example in this case is shown in FIG. 6. A system 500 shown in FIG. 6 includes a plurality of tabletop information processing apparatuses 100A to 100C, which have a configuration same as the configuration of the tabletop information processing apparatus 100, and a server 200. The tabletop information processing apparatuses 100A to 100C and the server 200 perform transmission and reception of data each other via a network 300. The server 200 has a configuration same as a conventional computer and includes a processor 211, a storage unit 212, a network I/F 213, a monitor 215, and a keyboard 214. The storage unit 212 includes a RAM for volatile storage and an auxiliary storage device and a ROM for nonvolatile storage. The tables shown in FIGS. 4A to 4C are stored in the storage unit 212 of the server 200.

When receiving telegraphic messages from the tabletop information processing apparatuses 100A to 100C, the processor 211 of the server 200 performs processing referring to the tables. In the flowchart of FIG. 5, ACT 001 and ACT 002 are operations in the tabletop information processing apparatuses 100A to 100C. After ACT 002, the tabletop information processing apparatuses 100A to 100C transmit telegraphic messages including determined commands and gesture IDs. Thereafter, processors of the tabletop information processing apparatuses 100A to 100C display a candidate list on the touch panel display 50 in ACT 010 and transmit gesture IDs designated by users to the server 200. The tabletop information processing apparatuses 100A to 100C perform the command execution in ACT 006 and ACT 013.

On the other hand, when the processor 211 of the server 200 receives the telegraphic massages including the determined commands and gesture IDs, the processor 211 performs the operations in ACT 002A to ACT 005 and ACT 007 to ACT 009. When the tabletop information processing apparatuses 100A to 100C perform candidate display in ACT 010, the processor 211 causes the network I/F 213 to operate and transmits information such as a candidate list and an operation procedure. When the server 200 receives gesture IDs designated by the users in ACT 010, the processor 211 performs the operations in ACT 011 to ACT 012.

In the explanation explained above, the server 200 is caused to store all the data shown in FIGS. 4A to 4C and performs the main processing such as the determination and the tabletop information processing apparatuses 100A to 100C receive results of the processing and mainly perform control of display. Besides, it is also possible to adopt, for example, implementation for causing the server 200 to store only the table shown in FIG. 4B or implementation for causing the server 200 to store the tables shown in FIGS. 4A and 4B. If the server 200 is caused to store at least the table shown in FIG. 4B, the server 200 can manage, for each of the users, history information of the number of misdetections and the like. The plurality of tabletop information processing apparatuses 100A to 100C can share the history information. In addition, if the server 200 is caused to store the table shown in FIG. 4A as well, when the maintenance person updates the table shown in FIG. 4A, the maintenance person can perform maintenance of only the server 200. If the server 200 is caused to store the table shown in FIG. 4A, inconsistency of the table shown in FIG. 4A does not occur among the tabletop information processing apparatuses 100A to 100C. Unitary management of data is easily performed.

In the embodiment, the form of the tabletop information processing apparatus is explained. However, the form of the embodiment is not limited to this. For example, the information processing apparatus according to the embodiment only has to be a computer including a touch panel display such as a tablet computer.

The control unit is equivalent to a configuration including at least the processor 10, the DRAM 20, and the communication bus 90 according to the embodiment. A computer program operating in cooperation with the respective kinds of hardware such as the processor 10, the DRAM 20, and the communication bus 90 is stored in the HDD 40 (or the ROM 30) in advance and loaded to the DRAM 20 by the processor 10 and operation of the computer program is executed. The control unit may be equivalent to the processor 211 of the server 200. The display unit and the input unit are equivalent to the touch panel display 50. The storing unit is equivalent to the DRAM 20, the HDD 40, or the storage unit 212. The video data is data for projecting an image and includes an image or a moving image.

A computer program for causing a computer to execute the functions explained in the embodiment may be provided. The computer program may be referred to as any name such as a display control program, a command execution program, a user interface program, or a device control program.

In the explanation in the embodiment, the functions for carrying out the invention are recorded in advance in the apparatus. However, the same functions may be downloaded from a network to the apparatus. The same functions stored in a recording medium may be installed in the apparatus. A form of the recording medium may be any form as long as the recording medium is a recording medium that can store a computer program and can be read by the apparatus such as a CD-ROM. The functions obtained by install or download in advance in this way may be realized in cooperation with an OS (Operating System) or the like in the apparatus.

As explained above in detail, according to the form of this embodiment, it is possible to suppress misdetection of user operation and execute a command desired by the user.

The present invention can be carried out in other various forms without departing from the spirit and main features of the present invention. Therefore, the embodiment is only mere illustration in all aspects and should not be limitedly interpreted. The scope of the present invention is indicated by the claims and is not restricted by the text of the specification at all. Further, all modifications and various improvements, substitutions, and alterations belonging to the scope of equivalents of the claims are within the scope of the present invention.

What is claimed is:

1. An information processing apparatus comprising:
a display unit;
a touch panel type input unit that is disposed on the display unit and configured to receive an operation input of a user through touch detection; and
a control unit configured to execute, if the input unit repeatedly receives the same user operation a plurality of times, a command conforming to first operation associated with the user operation.

2. The information processing apparatus according to claim 1, wherein
a plurality of kinds of the first operation corresponding to the user operation are present, and
if the input unit repeatedly receives the same user operation the plurality of times, the control unit acquires information respectively concerning the plurality of kinds of first operation from a storing unit, causes the display unit to display the information as a list in a state selectable by the user, and executes a command conforming to selected operation.

3. The information processing apparatus according to claim 2, wherein the control unit further acquires video data associated with the information concerning the first operation from the storing unit and causes the display unit to display the video data.

4. The information processing apparatus according to claim 2, wherein the control unit counts, for each of the plurality of kinds of first operation, a number of times the command conforming to the first operation is executed according to the plurality of times of repeated reception of the same user operation by the input unit and determines, on the basis of the count, display order of the information displayed as the list.

5. The information processing apparatus according to claim 3, wherein the control unit counts, for each of the plurality of kinds of first operation, a number of times the command conforming to the first operation is executed according to the plurality of times of repeated reception of the same user operation by the input unit and determines, on the basis of the count, display order of the information displayed as the list.

6. The information processing apparatus according to claim 1, wherein
a plurality of kinds of the first operation corresponding to the user operation are present, and
if the input unit repeatedly receives the same user operation the plurality of times, the control unit executes a command conforming to one kind of the first operation set in advance out of the plurality of kinds of first operation.

7. A method of controlling an information processing apparatus which including a display unit and an input unit of a touch panel type arranged on the display unit and configured to receive an operation input of a user through touch detection, comprising the steps of:
determining whether the input unit repeatedly receives the same user operation a plurality of times; and
executing, if the input unit repeatedly receives the same user operation the plurality of times, a command conforming to first operation associated with the user operation.

8. The method according to claim 7, wherein
a plurality of kinds of the first operation corresponding to the user operation are present, and
if the input unit repeatedly receives the same user operation the plurality of times, the control unit acquires information respectively concerning the plurality of kinds of first operation from a storing unit, causes the display unit to display the information as a list in a state selectable by the user, and executes a command conforming to selected operation.

9. The method according to claim 8, further comprising:
acquiring video data associated with the information concerning the first operation from the storing unit and causes the display unit to display the video data.

10. A computer-readable storage medium storing a program for causing a computer to execute processing, wherein the computer including a display unit and an input unit of a touch panel type arranged on the display unit and configured to receive an operation input of a user through touch detection, the steps:
determining whether the input unit repeatedly receives the same user operation a plurality of times; and
executing, if the input unit repeatedly receives the same user operation the plurality of times, a command conforming to first operation associated with the user operation.
